(19) United States
(12) Patent Application Publication
(10) Pub. No.: US 2022/0286962 A1
(43) Pub. Date: Sep. 8, 2022

(54) TERMINAL, COMMUNICATION SYSTEM, AND CONTROL METHOD

(71) Applicant: SHARP KABUSHIKI KAISHA, Sakai City, Osaka (JP)

(72) Inventors: KATSUTOSHI ISHIKURA, Sakai City, Osaka (JP); Tadashi AOKI, Sakai City, Osaka (JP); ATSUSHI YAMAZAKI, Sakai City, Osaka (JP); HIDEYUKI NAKANISHI, Sakai City, Osaka (JP)

(21) Appl. No.: 17/637,993

(22) PCT Filed: Mar. 11, 2021
(86) PCT No.: PCT/JP2021/009809

§ 371 Date: Feb. 24, 2022

(30) Foreign Application Priority Data
Mar. 27, 2020 (JP) 2020-058184

(51) Int. Cl. H04W 52/02; H04W 64/00

(52) U.S. Cl. CPC H04W 52/0229; H04W 52/0274; H04W 64/00

(57) ABSTRACT

To reduce power consumption of a terminal. A terminal including: a first communicator that performs wireless communication by a first communication method; a second communicator that performs wireless communication by a second communication method; a standby determiner that determines a communication method to be used for standby; and a power source controller that controls a power source of the second communicator on the basis of the communication method determined by the standby determiner.

### TECHNICAL FIELD

The present invention relates to a terminal, a communication system, and a control method.

This application claims the priority based on Patent Application No. 2020-058184 filed in Japan on Mar. 27, 2020, the contents of which are hereby incorporated herein.

### BACKGROUND ART

Patent Literature 1 describes a technique for realizing standby operation according to the characteristics of a terminal device.

Non-Patent Literature 1 describes the operation in a standby state of a terminal (UE: User Equipment) corresponding to a 5G (Fifth Generation Mobile Communication System) that operates in an SA (Standalone) mode.

### CITATION LIST

### Patent Literature

Patent Literature 1: Japanese Patent Laid-open No. 2008-61015

### Non-Patent Literature

Non-Patent Literature 1: 3GPP TS 38.304. “User Equipment (UE) procedures in Idle mode”, March, 2017

### SUMMARY OF THE INVENTION

### Problems to be Solved by the Invention

According to Non-Patent Literature 1, during a standby state, an optimum NR (New Radio) cell has to be detected. Therefore, even in a case where the terminal is in the standby state, a power source of a communicator and the like related to NR (NR-related part) is always in an on state. At least, the terminal turns on the power source of the NR-related part at the timing of the NR cell detection.

There are two modes of operation for the 5G network: namely, an NSA (Non-StandAlone) mode and an SA mode. The NSA mode has a form of controlling NR using LTE. In the NSA mode, the terminal transmits and receives control information to and from an LTE base station, and transmits and receives data to and from each of the LTE base station and the NR base station. The SA mode is a form of operating by NR only. In the SA mode, the terminal transmits and receives control information and data to and from the NR base station. For a terminal that supports both the NSA mode and the SA mode, the NR-related part of the terminal is turned on during standby. In a case where the terminal is used in an area where the 5G network is operated in the NSA mode, which is not compatible with the SA mode, the NR-related part is turned on even though it is not necessary to turn on the NR-related part during standby. Therefore, a standby current is consumed unnecessarily.

An object of an aspect of the present invention is to reduce power consumption of a terminal.

### Solution to Problem

A terminal of an aspect of the present invention includes: a first communicator that performs wireless communication by a first communication method; a second communicator that performs wireless communication by a second communication method; a standby determiner that determines a communication method to be used for standby; and a power source controller that controls a power source of the second communicator on the basis of the communication method determined by the standby determiner.

A communication system according to an aspect of the present invention is a communication system including a terminal and a base station, wherein the terminal includes: a first communicator that performs wireless communication by a first communication method; a second communicator that performs wireless communication by a second communication method; a standby determiner that determines a communication method to be used for standby; a power source controller that controls a power source of the second communicator on the basis of the communication method determined by the standby determiner; and a transmitter that transmits, to a base station, information including the communication method determined by the standby RAT determiner, and the base station includes a receiver that receives, from the terminal, the information including the communication method determined by the standby RAT determiner.

A control method of a terminal according to an aspect of the present invention is a control method of a terminal including a first communicator that performs wireless communication by a first communication method, and a second communicator that performs wireless communication by a second communication method, the control method including: a process for determining a communication method to be used for standby; and a process for controlling a power source of the second communicator on the basis of the determined communication method.

### BRIEF DESCRIPTION OF DRAWINGS

FIG. 1 is an example of a configuration diagram of a communication system according to a first embodiment.

FIG. 2 is an example of a configuration diagram of a terminal according to the first embodiment.

FIG. 3 is an example of a configuration diagram of an LTE base station according to the first embodiment.

FIG. 4 is an example of a configuration diagram of an NR base station according to the first embodiment.

FIG. 5 is an example of a sequence diagram of a control process of a communication system according to the first embodiment.

FIG. 6 is a detailed flowchart (No. 1) of a standby RAT determination process.

FIG. 7 is a detailed flowchart (No. 2) of a standby RAT determination process.

FIG. 8 is a detailed flowchart (No. 3) of a standby RAT determination process.

FIG. 9 is an example of a configuration diagram of a communication system according to a second embodiment.

FIG. 10 is an example of a sequence diagram of a control process of a communication system according to the second embodiment.

### MODE FOR CARRYING OUT THE INVENTION

Hereinafter, embodiments will be described with reference to the drawings. For the drawings, the same reference numerals are attached to the same or equivalent elements, and duplicate explanations will be omitted.

### First Embodiment

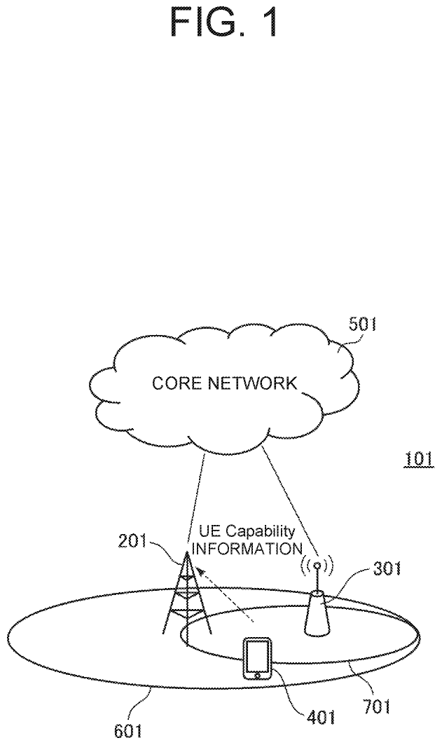

FIG. 1 is an example of a configuration diagram of a communication system according to a first embodiment.

A communication system 101 has an LTE base station 201, an NR base station 301, a terminal 401, and a core network 501.

The LTE base station 201 communicates with the terminal 401 in a cell 601 which is a range in which the LTE base station 201 can perform communication, by LTE (Long Term Evolution). LTE is an example of a first communication method.

The NR base station 301 communicates with the terminal in a cell 701 which is a range in which the NR base station 301 can perform communication, by 5G NR (New Radio) (hereinafter referred to as NR). The NR base station 301 is installed in the cell 601. NR is a radio system of a fifth generation mobile communication system. NR is an example of a second communication method.

Terminal 401 is a terminal capable of performing communication by LTE and NR. The terminal 401 is a communication terminal such as a smartphone, a tablet, and a laptop. In FIG. 1, the terminal 401 is in the cell 601, and communicates with the LTE base station 201 by LTE. The terminal 401 transmits UE Capability information indicating capability of the terminal 401 to the LTE base station 201. In addition, the terminal 401 controls a power source for a part related to NR in the terminal 401. The details of the control of the power source of the terminal 401 will be described later.

The core network 501 is a backbone network, for example, a network that controls a mobile network. The core network 501 is connected to the LTE base station 201 and the NR base station 301 to enable mutual communication.

In addition, the base stations (such as the LTE base station 201 and the NR base station 301) are directly connected to each other, and the base stations can communicate directly with each other without going through the core network 501.

The configuration of the communication system 101 described above is an example, and the number and arrangement of LTE base stations, NR base stations, and terminals are not limited to the configuration described above.

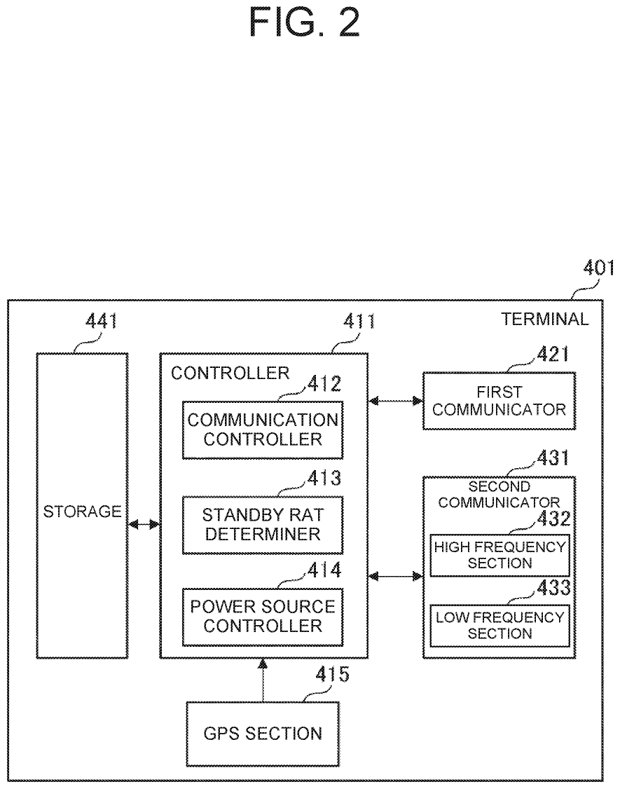

FIG. 2 is an example of a configuration diagram of the terminal according to the first embodiment.

The terminal 401 includes a controller 411, a first communicator 421, a second communicator 431, a storage 441, and a GPS section.

The controller 411 has a communication controller 412, a standby RAT determiner 413, and a power source controller 414.

The communication controller 412 performs various control related to communication of the terminal 401 such as processing of received data received from the first communicator 421 or the second communicator 431 and transmitted data transmitted from the first communicator 421 or the second communicator 431, and carrier frequency control of the first communicator 421 and the second communicator 431. The communication controller 412 transmits the UE Capability information including the standby RAT from either the first communicator 421 or the second communicator 431 to the LTE base station 201.

The standby RAT determiner (standby determiner) 413 determines a communication method (standby RAT (Radio Access Technology)) to be used during standby. The standby RAT may also include information indicating a frequency band in the communication method to be used during standby. Specifically, for example, the standby RAT determiner 413 determines standby with LTE only, or standby with either LTE or NR. In addition, in a case of standby with NR, the standby RAT determiner 413 can determine any of standby in a millimeter wave (mmW) from 24.25 GHz to 52.6 GHz in NR only, standby in a frequency band of less than 6 GHz called sub6 in NR only, or standby in either millimeter wave or sub6 in NR. Details of a process of determining the standby RAT will be described later. The standby RAT is, for example, “LTE only” that indicates standby with LTE only, “LTE+sub6” that indicates standby with either LTE or sub6 in NR, “LTE+mmW” that indicates standby with either LTE or millimeter wave (mmW) in NR, or “LTE+sub6+mmW” that indicates standby with any of LTE, sub6 in NR, and a millimeter wave in NR.

In addition, in a case where standby with any of a plurality of communication methods (or frequency bands) is determined by the standby RAT determiner 413, the communication controller 412 stands by with a communication method (or frequency band) of the best cell among cells of the plurality of communication methods (or frequency bands). For example, in a case where standby with either LTE or NR is determined by the standby RAT determiner 413, the communication controller 412 stands by with, for example, a communication method of the best cell among cells of LTE and NR detected by the cell search. Specifically, for example, in a case where the standby with either LTE or NR is determined by the standby RAT determiner 413, the communication controller 412 stands by with a communication method of the best cell of a signal with the highest reception level (best cell) among signals received from the respective cells of LTE and NR.

The power source controller 414 controls the power source of the second communicator 431 (power on or power off) on the basis of the determination result of the standby RAT determiner 413. For example, in a case where the standby RAT determiner 413 determines standby with LTE only, the power source controller 414 turns off the power source of the second communicator 431. The power source controller 414 controls respective power sources of a high frequency section 432 and a low frequency section 433 of the second communicator 431 on the basis of the determination result of the standby RAT determiner 413.

The first communicator 421 communicates with an LTE base station corresponding to a cell where the terminal 401 exists (that is, the LTE base station whose communication range is this cell), by LTE. For example, as illustrated in FIG. 1, the first communicator 421 of the terminal 401 that exists in the cell 601 communicates with the LTE base station 201, by LTE. The first communicator 421 is an example of a transmitter.

The second communicator 431 communicates with an NR base station corresponding to a cell where the terminal 401 exists (that is, the NR base station whose communication range is this cell), by NR. The second communicator 431 has the high frequency section 432 and the low frequency section 433. The second communicator 431 is an example of a transmitter.

The high frequency section 432 performs communication using a frequency band of a millimeter wave (mmW) of 24.25 GHz to 52.6 GHz in NR.

The low frequency section 433 performs communication in a frequency band lower than the millimeter wave in NR. Specifically, the low frequency section 433 performs communication using a frequency band of less than 6 GHz called sub6.

The storage 441 stores a program, data and the like to be used by the terminal 401. The storage 441 is, for example, a storage device such as a magnetic disk drive and a flash memory.

A GPS section 451 acquires position information indicating a position of the terminal 401 by a GPS (Global Positioning System), and outputs the position information to the controller 411.

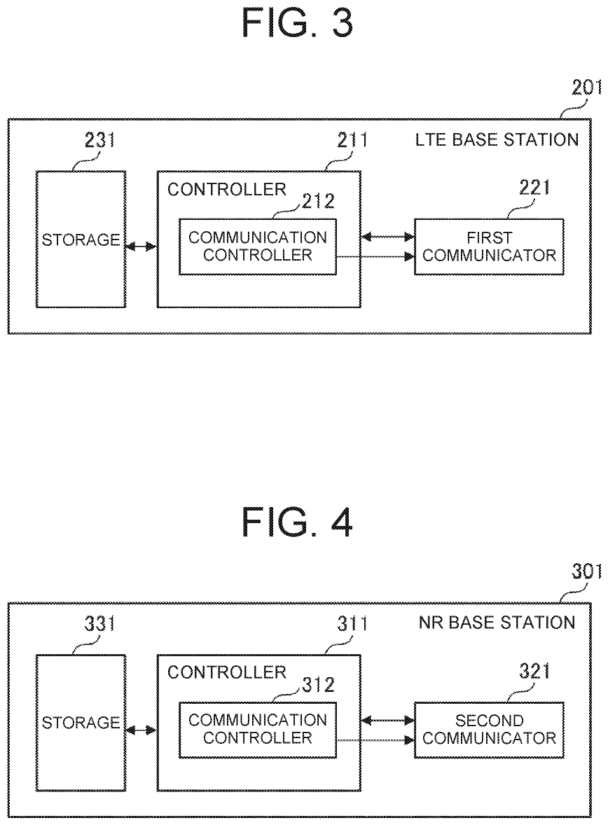

FIG. 3 is an example of a configuration diagram of the LTE base station according to the first embodiment.

The LTE base station 201 has a controller 211, a first communicator 221, and a storage 231. In addition, the LTE base station 201 is connected to the core network 501 via a communicator (not illustrated) to enable mutual communication.

The controller 211 has a communication controller 212. The communication controller 212 performs various control related to the communication of the LTE base station 201 such as a process of received data received from the first communicator 221 and transmitted data transmitted from the first communicator 221, and carrier frequency control of the first communicator 221.

The communication controller 212 transmits, via the first communicator 221, the notification information to the terminal 401 in the cell 601 within a range in which the LTE base station 201 can communicate. The notification information is transmitted periodically from the LTE base station 201, regardless of the presence or absence of the terminal 401 in the cell 601. Examples of the notification information include a PLMN (Public Land Mobile Network) to identify a business operator, a band number which indicates a frequency, and a Cell ID to sort the base station. Furthermore, the notification information includes area information that indicates whether or not there is the NR base station in the cell of the own base station. The area information is, for example, a 5G indicator in 5G (a parameter value of an upperLayerIndication in SIB2). In a case where there is the NR base station in the cell of the own base station, the 5G indicator is “1”, and in a case where there is not the NR base station in the cell of the own base station, the 5G indicator is “0”. For example, the storage 231 stores the area information that indicates whether or not there is the NR base station in the cell of the own base station, and the communication controller 212 refers to the area information and generates the notification information including the area information.

For example, there is the NR base station 301 in cell 601, and therefore the 5G indicator of the notification information transmitted by the LTE base station 201 is “1”.

The first communicator 221 communicates with the terminal in the cell 601 which is the range in which the LTE base station 201 can communicate, by LTE. Specifically, for example, as illustrated in FIG. 1, the first communicator 221 communicates with the terminal 401 in the cell 601, by LTE. The first communicator 221 receives the UE Capability information including the standby RAT from the terminal 401. The first communicator 221 is an example of a receiver.

The storage 231 stores programs, data, and the like used by the LTE base station 201. The storage 231 is, for example, a storage device such as a magnetic disk drive and a flash memory.

FIG. 4 is an example of a configuration diagram of the NR base station according to the first embodiment.

The NR base station 301 has a controller 311, a second communicator 321, and a storage 331. The NR base station 301 is connected to the core network 501 via a communicator (not illustrated) to enable mutual communication.

The controller 311 has a communication controller 312. The communication controller 312 performs various control related to the communication of the NR base station 301 such as a process of received data received from the second communicator 321 and transmitted data transmitted from the second communicator 321, and carrier frequency control of the second communicator 321.

The second communicator 321 communicates with the terminal in the cell 701 which is a range in which the NR base station 301 can communicate, by NR. The second communicator 321 receives the UE Capability information including the standby RAT from the terminal 401. The second communicator 321 is an example of a receiver.

The storage 331 stores programs, data, and the like used by the NR base station 301. The storage 331 is, for example, a storage device such as a magnetic disk drive and a flash memory.

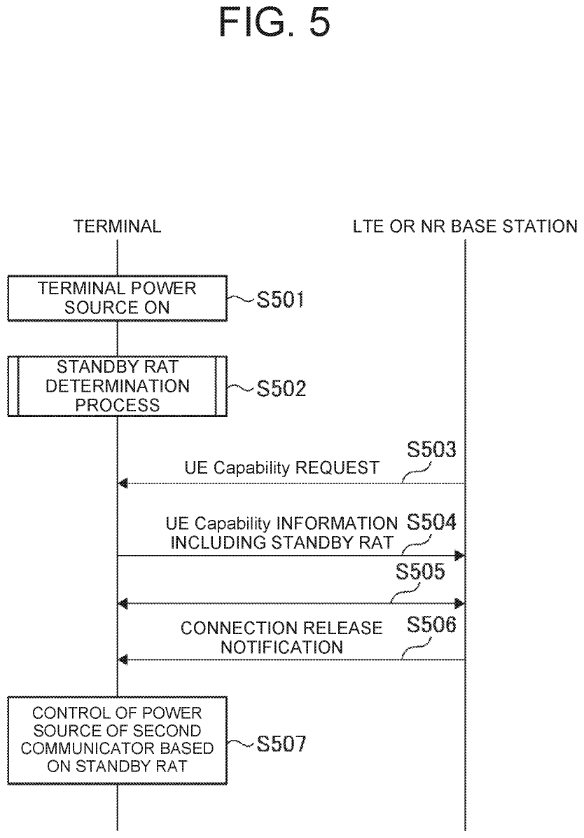

FIG. 5 is an example of a sequence diagram of a control process of a communication system according to the first embodiment. Herein, a case where communication between the terminal 401 and the LTE base station 201 is performed will be described.

In Step S501, the power source of the terminal 401 is turned on by operation of a user, and the power source controller 414 turns on the respective power sources of the first communicator 421 and the second communicator 431.

In Step S502, the standby RAT determiner 413 performs a standby RAT determination process. By the standby RAT determination process, a communication method (standby RAT) to be used by the terminal 401 during standby is determined. The standby RAT may also include information indicating a frequency band in the communication method to be used during standby. Details of the standby RAT determination process will be described later. The standby RAT is, for example, “LTE only” that indicates standby with LTE only, “LTE+sub6” that indicates standby with either LTE or sub6 in NR, “LTE+mmW” that indicates standby with either LTE or millimeter wave (mmW) in NR, or “LTE+sub6+mmW” that indicates standby with any of LTE, sub6 in NR, and a millimeter wave in NR.

In Step S503, the communication controller 212 of the LTE base station 201 transmits a UE Capability request to the terminal 401.

In Step S504, when the communication controller 412 receives the UE Capability request, the UE Capability information indicating capability of the terminal 401 including the standby RAT determined in Step S502 is transmitted to the LTE base station 201. Consequently, the communication controller 412 notifies the LTE base station 201 of the standby RAT of the terminal 401. In addition, the communication controller 412 may include the standby RAT in the UE Capability information only in a case where the standby RAT is “LTE only”.

In Step S505, the communication controller 412 performs data communication with the LTE base station 201.

In Step S506, the communication controller 212 of the LTE base station 201 transmits a connection release notification to the terminal 401 when the connection with the terminal 401 is terminated.

In Step S507, the power source controller 414 controls the power source of the second communicator 431 on the basis of the standby RAT determined in Step S502. The power source of the first communicator 421 is turned on.

Specifically, for example, in a case where the standby RAT is determined to be “LTE only” in Step S502, the power source controller 414 turns off the power source of the second communicator 431 in S507 because no standby is performed in NR.

Specifically, for example, in a case where the standby RAT is determined to be “LTE+sub6” in Step S502, the power source controller 414 turns off the power source of the high frequency section 432 in S507 because no standby is performed in the millimeter wave of NR. The power source controller 414 turns on the power source of the low frequency section 433.

Specifically, for example, in a case where the standby RAT is determined to be “LTE+mmW” in Step S502, the power source controller 414 turns off the power source of the low frequency section 433 in S507 because no standby is performed in sub6 of NR. The power source controller 414 turns on the power source of the high frequency section 432.

Specifically, for example, in a case where the standby RAT is determined to be “LTE+sub6+mmW” in Step S502, the power source controller 414 turns on the power sources of the high frequency section 432 and the low frequency section 433 because the power source controller 414 performs standby with any of LTE, sub6 in NR, and the millimeter wave in NR in Step S507.

After Step S507, the communication controller 412 performs standby on the basis of the standby RAT determined in Step S502. Specifically, for example, in a case where the standby RAT is “LTE only”, the communication controller 412 stands by with LTE only. Specifically, for example, in a case where the standby RAT is “LTE+sub6”, the communication controller 412 stands by with a communication method (frequency band) of a better quality cell among a cell of LTE and a cell of sub6 detected by a cell search. Specifically, for example, in a case where the standby RAT is “LTE+mmW”, the communication controller 412 stands by with a communication method (frequency band) of a better quality cell among a cell of LTE and a cell of a millimeter wave detected by a cell search. Specifically, for example, in a case where the standby RAT is “LTE+sub6+mmW”, the communication controller 412 stands by with a communication method (frequency band) of the best quality cell among a cell of LTE, cell of sub6, and a cell of a millimeter wave detected by a cell search.

In the above process, the case of communication between the terminal 401 and the LTE base station 201 is described. The same applies to the case of communication between the terminal 401 and the NR base station 301.

In the communication system 101 of the first embodiment, when the LTE base station 201 receives the UE Capability information that the standby RAT is “LTE only”, in a case where a communication request to the terminal 401 is generated, even when the NR base station corresponding to an SA mode exists in a paging area, the core network 501 controls such that no paging signal is output from the base station corresponding to the SA mode, and only the LTE base station transmits a paging signal to the terminal 401. Consequently, it is possible to reduce a communication control load.

Now, details of a standby RAT determination process will be described.

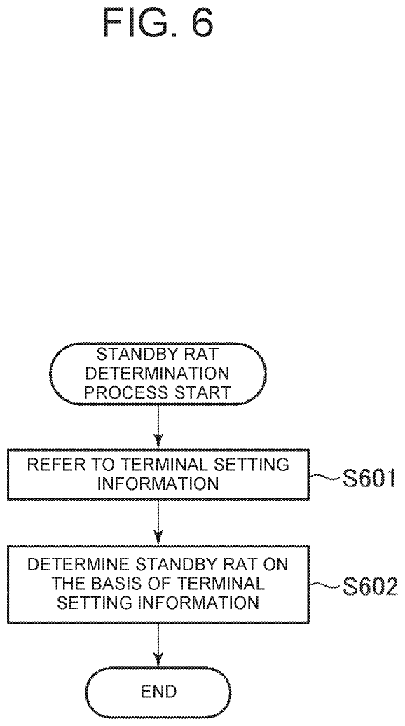

FIG. 6 is a detailed flowchart (No. 1) of the standby RAT determination process. FIG. 6 corresponds to Step S502 of FIG. 5.

In Step S601, the standby RAT determiner 413 refers to terminal setting information stored in the storage 441. The terminal setting information includes the standby RAT. The terminal setting information may be set in advance by the user, for example, or may be stored in advance from outside of the terminal 401 such as the LTE base station 201.

In Step S602, the standby RAT determiner 413 determines the standby RAT on the basis of the terminal setting information referred to in Step S601. Specifically, for example, the standby RAT determiner 413 determines the standby RAT included in the terminal setting information referred to in Step S601 as the communication method (standby RAT) to be used by the terminal 401 during standby. Specifically, for example, in a case where “LTE only” is included as the standby RAT in the terminal setting information, the standby RAT determiner 413 determines the standby RAT to be “LTE only”.

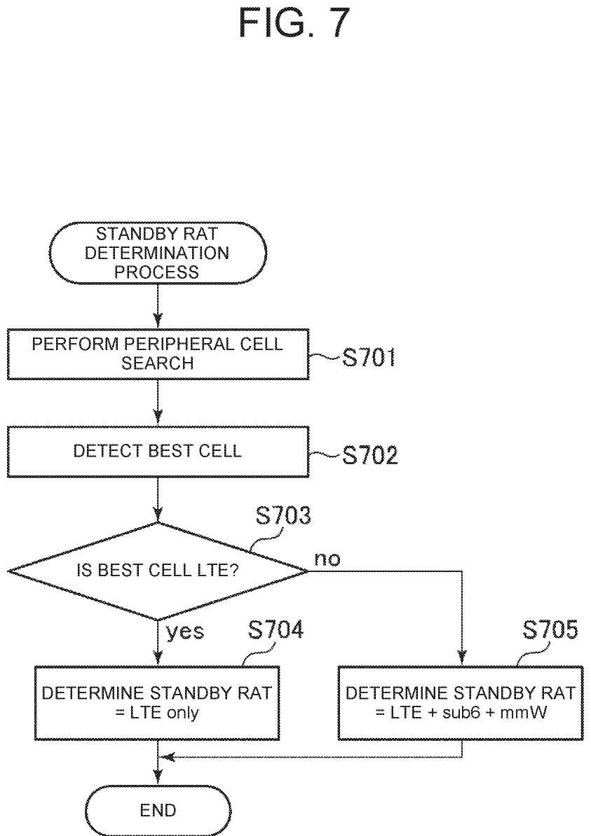

The standby RAT determination process may be a method using a cell search illustrated in FIG. 7.

FIG. 7 is a detailed flowchart (No. 2) of the standby RAT. FIG. 7 corresponds to Step S502 in FIG. 5.

In Step S701, the communication controller 412 performs a cell search (neighboring cell search) to find a base station around the terminal 401, and receives signals from the cells where the terminal 401 is located (specifically, the LTE base station and the NR base station corresponding to the cells).

In Step S702, the communication controller 412 detects the cell with the highest quality (the best cell). Specifically, for example, the communication controller 412 detects the cell of the signal having the highest reception level among the respective signals received from the cells by the neighboring cell search.

In Step S703, the standby RAT determiner 413 determines whether or not the best cell detected in Step S702 is LTE. In a case where it is determined that the cell is LTE, the control proceeds to Step S704, and in a case where it is determined that the best cell is not LTE (i.e., the best cell is NR), the control proceeds to Step S705. The “cell is LTE” means that the base station which uses the cell as its communication range (the base station corresponding to the cell) is the LTE base station. The “cell is NR” means that the base station which uses the cell as its communication range is the NR base station.

In Step S704, the standby RAT determiner 413 determines the standby RAT to be “LTE only”. In a case where the best cell is LTE (Step S703: Yes), the standby RAT is determined to be “LTE only” because standby with NR is not necessary, and the power source of the second communicator 431 is turned off in Step S507 of FIG. 5. Consequently, the power consumption of the terminal 401 during standby is reduced.

In Step S705, the standby RAT determiner 413 determines the standby RAT to be “LTE+sub6+mmW”.

As a modification of a flowchart of FIG. 7, in Step S702, the communication controller 412 may determine whether or not there is a signal from the NR base station corresponding to the SA mode in respective signals received from cells by the neighboring cell search. Then, in Step S703, in a case where the standby RAT determiner 413 determines that there is the signal from the NR base station corresponding to the SA mode in Step S702, it is determined that the NR base station corresponding to the SA mode is around the terminal 401, and the control proceeds to Step S705. In a case where the standby RAT determiner 413 determines that there is not the signal from the NR base station corresponding to the SA mode in Step S702, it is determined that the NR base station corresponding to the SA mode is not around the terminal 401, and the control may proceed to Step S704. Thus, depending on determination as to whether or not the NR base station corresponding to the SA mode is around the terminal 401, the standby RAT may be determined and the power source of the second communicator 431 may be controlled.

In addition, the standby RAT determiner 413 may determine whether or not the NR base station corresponding to the SA mode is around the terminal 401, on the basis of the notification information transmitted from the LTE base station 201. In this case, the LTE base station 201 includes, for example, information indicating whether or not there is the NR base station corresponding to the SA mode around the LTE base station 201 (for example, in the cell 601 that is the communication range of the LTE base station 201), in the notification information.

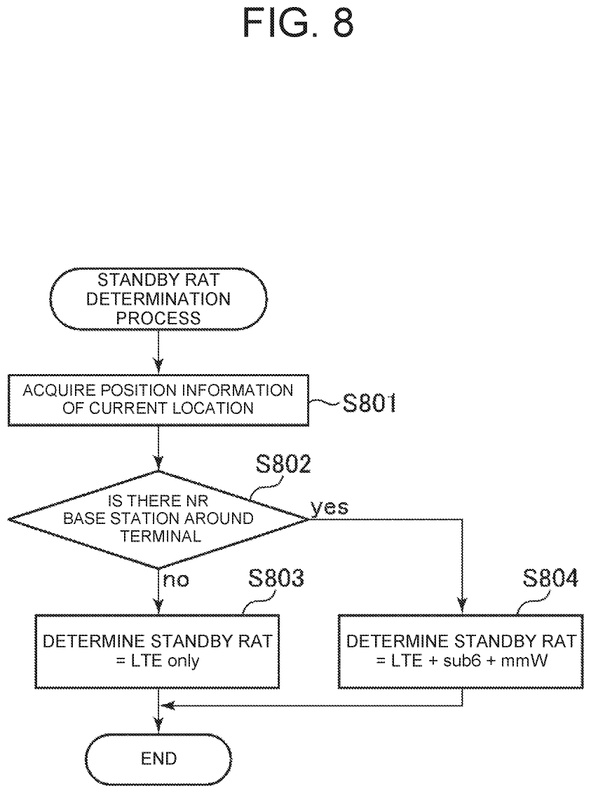

The standby RAT determination process may be a method using position information illustrated in FIG. 8.

FIG. 8 is a detailed flowchart (No. 3) of the standby RAT determination process. FIG. 8 corresponds to Step S502 of FIG. 5. It is assumed that the storage 441 stores NR base station position information including position information indicating a position of the NR base station (specifically, the NR base station corresponding to the SA mode).

In Step S801, the GPS section 451 acquires position information indicating the position of the terminal 401 (terminal position information) by the GPS, and outputs the terminal position information to the controller 411.

In Step S802, the standby RAT determiner 413 refers to the NR base station position information stored in the storage 441, and determines whether or not there is the NR base station corresponding to the SA mode around the terminal 401, from the NR base station position information and the terminal position information. Around the terminal 401 is, for example, within a radius of a km from the center of the terminal 401 (where a is a preset threshold value). In a case where it is determined that there is the NR base station corresponding to the SA mode around the terminal 401, the control proceeds to Step S804, and in a case where it is determined that there is not the NR base station corresponding to the SA mode around the terminal 401, the control proceeds to Step S803.

In Step S803, the standby RAT determiner 413 determines the standby RAT to be “LTE only”. In a case where there is not the NR base station corresponding to the SA mode around the terminal 401 (Step S802: No), the standby RAT is determined to be “LTE only” because standby with NR is not necessary, and the power source of the second communicator 431 is turned off in Step S507 of FIG. 5. Consequently, the power consumption of the terminal 401 during standby is reduced.

In Step S804, the standby RAT determiner 413 determines the standby RAT to be “LTE+sub6+mmW”.

According to the first embodiment, for example, for example, in a case where the standby with NR is not necessary, the power source of the second communicator which communicates by NR is turned off, so that it is possible to reduce power consumption of the terminal during standby.

### Second Embodiment

In the first embodiment, the case where the terminal 401 transmits the standby RAT included in the UE Capability information is described. In the second embodiment, a case where the terminal 401 transmits standby RAT included in a cell update message will be described.

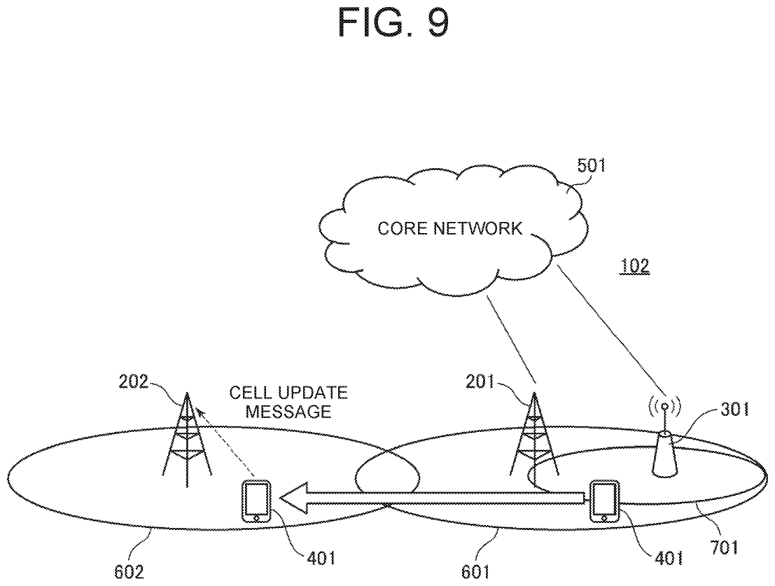

FIG. 9 is an example of a configuration diagram of a communication system according to a second embodiment.

A communication system 102 has LTE base stations 201 and 202, an NR base station 301, a terminal 401, and a core network 501.

The LTE base station 201 communicates with the terminal 401 in a cell 601 which is a range in which the LTE base station 201 can perform communication, by LTE. The LTE base station 202 communicates with the terminal 401 in a cell 602 which is a range in which the LTE base station 202 can perform communication, by LTE. A detailed configuration of the LTE base station 201 is described in FIG. 3, and therefore will be omitted. The LTE base station 202 has the same configuration and function as the LTE base station 201.

The NR base station 301 communicates with the terminal in a cell 701 which is an area where the NR base station 301 can perform communication, by NR. The NR base station 301 is installed in the cell 601. A detailed configuration of the NR base station 301 is described in FIG. 4, and therefore will be omitted.

The terminal 401 is a terminal capable of performing communication by LTE and NR. The terminal 401 is a communication terminal such as a smartphone, a tablet, and a laptop. A detailed configuration of the terminal 401 is described in FIG. 2, and therefore will be omitted.

FIG. 9 illustrates a case where the terminal 401 moves from the cell 601 to the cell 602, and when the terminal 401 moves from the cell 601 to the cell 602, the terminal 401 transmits a cell update message including standby RAT to the LTE base station 202.

The core network 501 is a backbone network, for example, a network that controls a mobile network. The core network 501 is connected to the LTE base stations 201 and 202 and the NR base station 301 to enable mutual communication.

In addition, the base stations (such as the LTE base station 201 and the LTE base station 202, and the LTE base station 201 and the NR base station 301) are directly connected to each other, and the base stations can communicate directly with each other without going through the core network.

The configuration of the communication system 102 described above is an example, and the number and arrangement of LTE base stations, NR base stations, and terminals are not limited to the configuration described above.

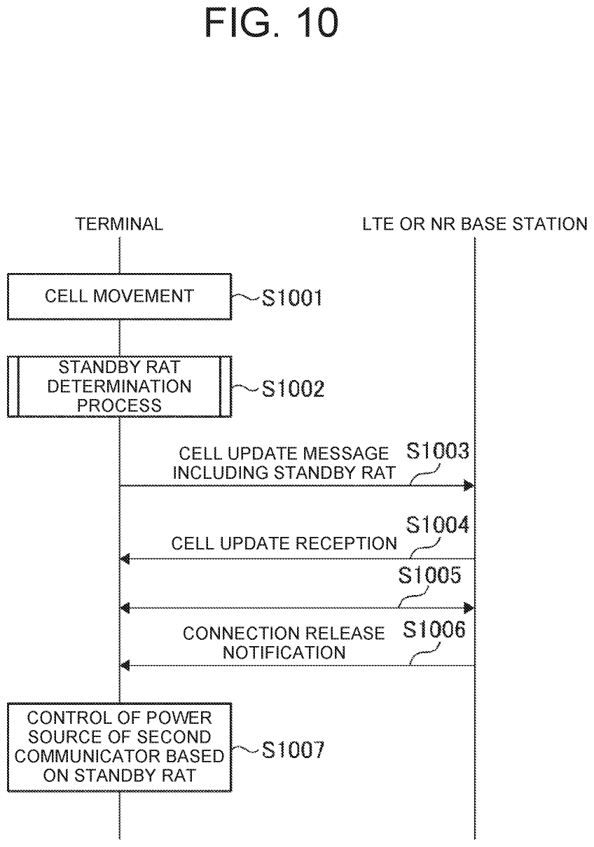

FIG. 10 is an example of a sequence diagram of a control process of a communication system according to the second embodiment. Herein, as illustrated in FIG. 9, a case where the terminal 401 moves from the cell 601 to the cell 602 to communicate with the LTE base station 202 will be described.

In Step S1001, the terminal 401 moves from the cell 601 to the cell 602, and the terminal 401 detects movement to a different cell. For example, the communication controller 412 monitors respective signals received from the cells, and the terminal 401 detects that the terminal 401 moves from the cell 601 to the cell 602, by change from a state in which the reception level of the signal of the cell 601 is the highest to a state in which the reception level of the signal of the cell 602 is the highest.

In Step S1002, when the terminal 401 detects the movement to the different cell, the standby RAT determiner 413 performs a standby RAT determination process. By the standby RAT determination process, a communication method (standby RAT) to be used by the terminal 401 during standby is determined. The standby RAT determination process in Step S1002 is the same as the standby RAT determination process in Step S502 of FIG. 5, and therefore the description will be omitted.

In Step S1003, the communication controller 412 transmits, to the LTE base station 202, a cell update message (Cell Update Message) including the standby RAT determined in Step S1002. The cell update message is a message notifying that the terminal 401 moves to the different cell. Only in a case where the standby RAT is “LTE only”, the communication controller 412 may include the standby RAT in the cell update message.

In Step S1004, the first communicator 221 of the LTE base station 202 receives a standby cell update message from the terminal 401, and the communication controller 212 responds to the terminal 401 that the cell update is accepted.

In Step S1005, the communication controller 412 performs data communication with the LTE base station 202.

In Step S1006, the communication controller 212 of the LTE base station 202 transmits a connection release notification to the terminal 401 when the connection with the terminal 401 is terminated.

In Step S1007, the power source controller 414 controls the power source of the second communicator 431 on the basis of the standby RAT determined in Step S1002. The power source of the first communicator 421 is turned on. The power source control of the second communicator 431 based on the standby RAT is the same as that of the first embodiment, and therefore the description will be omitted.

After Step S1007, the communication controller 412 stands by on the basis of the standby RAT determined in Step S1002. The standby process based on the standby RAT is the same as that of the first embodiment, and therefore the description will be omitted.

In the communication system 102 of the second embodiment, when the LTE base station 201 receives the cell update message that the standby RAT is “LTE only”, in a case where a communication request to the terminal 401 is generated, even when the NR base station corresponding to an SA mode exists in a paging area, the core network 501 controls such that no paging signal is output from the base station corresponding to the SA mode, and only the LTE base station transmits a paging signal to the terminal 401. Consequently, it is possible to reduce a communication control load.

According to the second embodiment, for example, in a case where the standby with NR is not necessary, the power source of the second communicator which communicates by NR is turned off, so that it is possible to reduce power consumption of the terminal during standby.

(Example of Realization by Software)

Control blocks of the LTE base stations 201 and 202, the NR base station 301, and the terminal 401 (especially the controllers 211, 311 and 411) can be each realized by a logic circuit (hardware) formed in an integrated circuit (IC (Integrated Circuit) chip) or the like, or may be each realized by software using a CPU (Central Processing Unit). In the latter case, the LTE base stations 201 and 202, the NR base station 301, and the terminal 401 each include a CPU that executes instructions of a program which is the software that realizes each function, a ROM or a storage device recorded such that the above program and various data can be read by a computer (or CPU) (these are referred to as a “recording medium”), and a RAM in which the above program is deployed, and the like. The computer (or CPU) reads the above program from the above recording medium and executes the program, so that an object of the present invention is achieved. As the above recording medium, a “non-temporary tangible medium” such as a tape, a disk card, a semiconductor memory, and a programmable logic circuit can be used. The above program may be supplied to the above computer via any transmission medium that can be transmitted.

The present invention is not limited to the above-described embodiments and can be modified, and the above-described configuration can be replaced by a substantially identical configuration, a configuration that produces the same effect, or a configuration that can achieve the same purpose.

1. A terminal comprising:
a first communicator that performs wireless communication by a first communication method;
a second communicator that performs wireless communication by a second communication method;
a standby determiner that determines a communication method to be used for standby; and
a power source controller that controls a power source of the second communicator on the basis of the communication method determined by the standby determiner.

2. The terminal according to claim 1, wherein
in a case where the standby determiner determines standby with the first communication method only, the power source controller turns off the power source of the second communicator.

3. The terminal according to claim 1, wherein
the standby determiner determines the communication method to be used for the standby, on the basis of whether or not a best cell detected by a cell search is a cell of the first communication method.

4. The terminal according to claim 1, wherein
the standby determiner determines the communication method to be used for the standby, on the basis of whether or not a base station that performs wireless communication by the second communication method corresponding to an SA mode is present around the terminal.

5. The terminal according to claim 4, further comprising a GPS (Global Positioning System) section that acquires terminal position information indicating a position of the terminal, wherein
the standby determiner determines whether a base station that performs wireless communication by the second communication method corresponding to an SA mode is present around the terminal, on the basis of the terminal position information and base station position information indicating a position of the base station that performs wireless communication by the second communication method corresponding to the SA mode, and determines the communication method to be used for the standby on the basis of a result of the determination.

6. The terminal according to claim 1, further comprising a transmitter that transmits, to a base station, information including the communication method determined by the standby RAT determiner.

7. The terminal according to claim 1, wherein
the first communication method is LTE (Long Term Evolution), and the second communication method is NR (New Radio).

8. A communication system comprising:
a terminal; and
a base station, wherein
the terminal includes:
a first communicator that performs wireless communication by a first communication method;
a second communicator that performs wireless communication by a second communication method;
a standby determiner that determines a communication method to be used for standby;
a power source controller that controls a power source of the second communicator on the basis of the communication method determined by the standby determiner; and
a transmitter that transmits, to a base station, information including the communication method determined by the standby RAT determiner, wherein
the base station includes a receiver that receives, from the terminal, the information including the communication method determined by the standby RAT determiner.

9. A control method of a terminal comprising a first communicator that performs wireless communication by a first communication method, and a second communicator that performs wireless communication by a second communication method, the terminal comprising:
a process for determining a communication method to be used for standby; and
a process for controlling a power source of the second communicator on the basis of the determined communication method.
